(19) United States
(12) Patent Application Publication
(10) Pub. No.: US 2011/0068912 A1
(43) Pub. Date: Mar. 24, 2011

(54) INDUCTIVE SENSOR MODULE FOR A VEHICLE AND METHOD FOR OPERATING SUCH A SENSOR MODULE

(76) Inventors: Bernd Tollkuehn, Ludwigsburg (DE); Peter Guse, Stutgart (DE)

(21) Appl. No.: 12/993,873

(22) PCT Filed: Mar. 12, 2010
(86) PCT No.: PCT/EP2010/053153

§ 371 Date: Nov. 22, 2010

(30) Foreign Application Priority Data
Mar. 17, 2009 (DE) 10 2009 001 617.1

(51) Int. Cl. B60Q 1/00

(52) U.S. Cl. 340/441; 340/425.5

(57) ABSTRACT

The invention relates to a sensor module for a vehicle safety system and to a method for actuating such a sensor module for a vehicle safety system, wherein data are wirelessly transmitted by at least one transmitter of the sensor module according to a sensor signal. The sensor module uses a generational measurement principle so that the energy for the operation of the sensor module is generated by said measurement principle. The data are stored in a memory in the sensor module, and a control device reads out said data according to at least one vehicle variable (e.g., speed) and/or event (e.g., slipping, blocking) and transmits said data.

### BACKGROUND INFORMATION

The invention relates to a sensor module for a vehicle safety system and a method for operating such a sensor module, according to the preamble of the independent claims.

DE 11 2006 003 053 T5 makes known a wireless angular velocity sensor which measures the speed of a motor vehicle wheel and processes the measured values registered by the sensor into a data telegram that indicates the wheel speed. Furthermore, the sensor is configured such that the data telegram is transmitted wirelessly. To measure the wire speed, a measurement unit measures changes in the magnetic flux and wirelessly transmits a related signal to a base station or a control unit. The present sensor component comprises a battery or another type of energy or power source that generally delivers relatively little current, such as that from a low-voltage power supply. Furthermore, a so-called ECU component can instruct the sensor component to switch to a sleep mode to save battery power since the vehicle can be at a standstill. U.S. 2004/0150516 A1 makes known a wireless speed sensor system, in the case of which the required energy is generated and/or stored to supply the wireless speed sensor. An energy management system is provided that uses a generator to generate energy by utilizing the rotation of the vehicle wheel to generate energy. A high efficiency, rechargeable battery or a super capacitor are used as storage devices. A rotational multi-polar generator can be used as the generator. The transmitter can be switched to a sleep mode or an inactive state until the control unit wakes up the sensor using the transmission module thereof.

### DISCLOSURE OF THE INVENTION

In contrast, the sensor module according to the invention for a vehicle safety system and the related method for operating such a sensor module have the advantage that the sensor module comprises a memory for the data, and a control unit, wherein the control unit reads out and transmits data depending on at least one vehicle parameter and/or one event. Case-dependent transmission is thereby made possible, which reduces energy consumption while not limiting the temporal continuity of the data. An exact analysis can therefore be carried out in the evaluation algorithm in a control unit e.g. to control brakes. The invention is of great benefit for speed sensors in particular since four speed sensors are typically disposed in a vehicle, i.e. one for each wheel, thereby enabling the radio traffic to be reduced to a minimum. By providing a memory in the sensor module, it is possible for initial analyses to be carried out in the sensor module itself, thereby relieving the control unit of the task of performing such analyses, as the recipient of the transmitted wireless signals. This adds the advantage of speed to the evaluation of the data.

In the present context, a sensor module refers to a structural unit such as a speed sensor or an acceleration sensor or rate-of-turn sensor or air pressure sensor or structure-borne sound sensor. In particular, additional components such as a steel wheel or a multi-polar encoder can also be assigned to the sensor module. The sensor module can include the sensor element itself which, in the present case, can employ e.g. the Hall effect, the anisotropic magnetoresistive effect (AMR), and the giant magnetoresistance effect (GMR effect). An ASIC, i.e. an application-specific integrated circuit, which preprocesses the sensor signals is typically provided in addition to the sensor element. The sensor module is a closed structural unit. Connecting means are provided only for the installation site.

The vehicle safety system is e.g. a vehicle dynamics control system, a brake system, and/or an air bag system.

The transmitter for the wireless transmission of data depending on the sensor signal is at least one radio transmitter that can utilize e.g. great frequency spreading such as DSSS: Direct Sequence Spread Spectrum, or a continuous change in the transmission frequency (FHSS: Frequency Hopping Spread Spectrum). A so-called RFID, i.e. transponder technology, can also be used in the present case. The power supply can also be provided in the form of emitted electromagnetic waves, wherein the induced current is rectified in an antenna coil in the sensor module and charges an energy accumulator. The energy accumulator supplies the chip with current for the reading procedure, or can be used only to supply the microchip. The signal is transmitted directly by the transmitter in a control unit, or by an external transmitter to the sensor. The RFID tag modulates the electromagnetic wave, thereby transmitting information.

The data are e.g. data telegrams which contain the actual sensor values. The sensor signal represents the sensor values that are output by the sensor element. It can be a multiplex of sensor signals. This data telegram can include useful data e.g. the sensor values, and additional data such as identification data or additional data on error correction.

A measurement principle that functions as a generator is understood to be a measurement principle in which energy is generated simultaneously with the measurement procedure. A preferred embodiment thereof is an inductive measurement principle, although other measurement principles are possible, such as a piezoelectric measurement principle or a vibration transducer. The measurement principle therefore describes a measuring device that simultaneously generates energy.

The memory is typically an electronic memory in which data can be stored. This memory is typically provided as an integrated circuit. The control unit can be an application-specific integrated circuit (ASIC) or a programmable component such as a microcontroller or a microprocessor. A mechanical control unit that responds to the vehicle parameter or an event can also be provided in the current case.

The expression “operate the sensor module” means “start up the sensor module”.

The dependent claims describe advantageous developments and improvements of the sensor module indicated in the independent claims, and a method for operating such a sensor module for a vehicle safety system.

Advantageously, the memory is designed as a circular memory. A circular memory is understood to be a memory that stores data continually within a certain period of time and overwrites them once a specified period of time has passed, to make memory space available for new data.

It is also advantageous that the memory and the control unit are disposed on an integrated circuit. This results in a compact design and reduces the amount of space required by the sensor module. Reliability can also be increased as a result.

A further advantage is that the device is configured such that the energy and the sensor signal are generated by induction via linear motion or rotary motion.

According to a further advantage, the sensor module is configured for a low power mode and a high power mode, wherein the sensor module comprises a switch that switches between the low power mode and the high power mode depending on the vehicle parameter and/or an event. The “low power mode” refers to a state in which the sensor module consumes very little energy, while the high power mode requires a greater amount of energy i.e. the high power mode consumes more energy than does the low power mode.

The switch can typically be software, or electronic or mechanical in design. The action on this switch takes place as a function of the vehicle parameter e.g. the vehicle speed and/or an event such as a wheel state such as slip or locked wheels. Dependence on a rule exists due to the event-dependent control of the switch. In particular, the data transmission rate of the transmitter can take place as a function of vehicle speed or in a rule-based manner. In the first case, at a low speed, the data are processed using a low clock frequency in a microcontroller or another processor or evaluation circuit, and are transmitted at a low data rate by the sensor module to a control unit; these conditions are reversed at high speeds. In event-controlled control of the switch, the clock frequency for data processing in the microcontroller and the data transmission rate during normal operation are low. Only basic monitoring is carried out in the low power mode within a specified time frame. As necessary, e.g. if slip occurs or if the wheels are locked, the signals are processed in the microcontroller at a higher clock frequency, and the speed gradient and/or the absolute speed are transmitted at a high data rate. Speed-dependent or rule-based signal transmission can be combined, of course.

Advantageously, the sensor module comprises energy management with this switch, which is disposed on an integrated circuit on which preprocessing of the sensor signal is also provided. These functions can therefore be combined with one another on an ASIC, and a particularly cost-favorable, compact manufacturing method can be selected.

Embodiments of the invention are presented in the drawing and are described in greater detail in the description that follows.

In the Drawings:

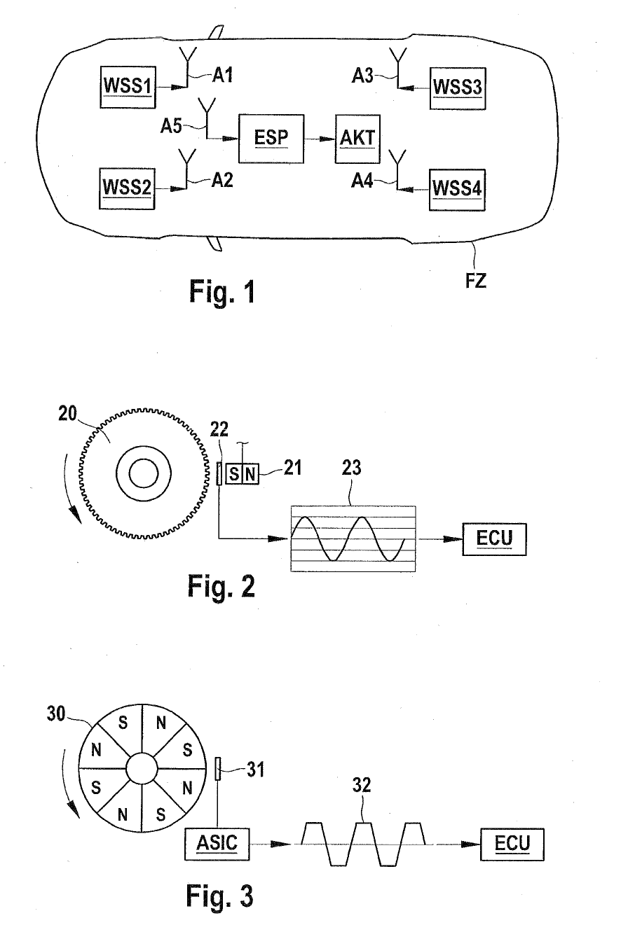

FIG. 1 shows a block diagram of a vehicle safety system,

FIG. 2 shows a first embodiment of a speed sensor,

FIG. 3 shows a second embodiment of a speed sensor,

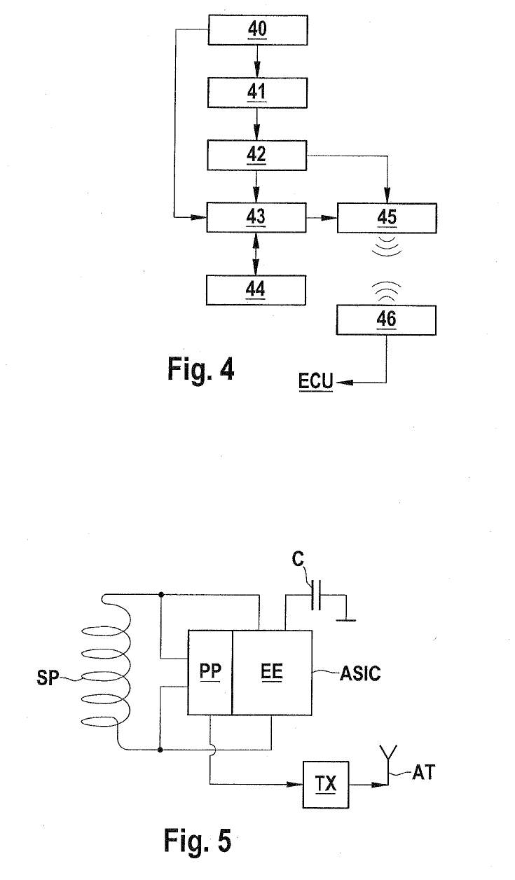

FIG. 4 shows a block diagram of the sensor module according to the invention, and a control unit,

FIG. 5 shows a circuit part of the sensor module related to power supply and sensor signal generation,

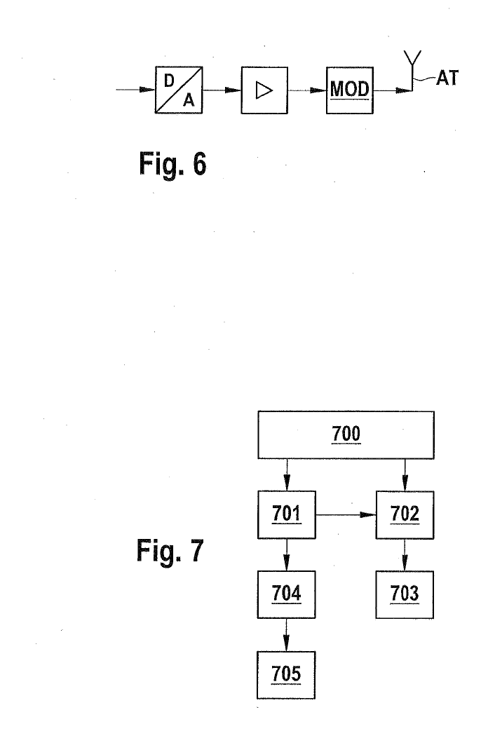

FIG. 6 shows a block diagram of the transmitter, and

FIG. 7 shows a flow chart of the method according to the present invention.

FIG. 1 shows, in a block diagram, a vehicle safety system in a vehicle FZ which has four speed sensors WSS1 through 4, a control unit for the vehicle dynamics control system ESP, and an actuator system AKT which is controlled by the ESP control unit. Speed sensors WSS1 through 4 are connected via wireless transmission to control unit ESP, and therefore speed sensors WSS1 through 4 each have antenna A1 through A4 to transmit their data to control unit ESP, wherein control unit ESP has antenna A5 for receiving these data. Therefore, at least each speed sensor WSS1 through 4 comprises a transmission module to transmit data to control unit ESP, e.g. using a frequency-spreading method, wherein control unit ESP comprises at least one receiving device in order to correctly receive and demodulate the signals. It is possible for the wireless connection between speed sensors WSS1 through 4 and control unit ESP to be unidirectional from the speed sensors to control unit ESP, or bidirectional. A broadcast mode is also possible. This means that a sensor transmits data to all recipients without addressing a specific recipient, as is typical for radio transmissions.

It is also possible for the speed sensors to transmit their data to another device, e.g. another sensor, which is connected by wire to control unit ESP, thereby performing this second part by transmitting the data in a wired manner. Control device ESP controls sensor system AKT, e.g. brakes, depending on this sensor and other sensor signals. In addition to speed sensors WSS1 through 4 presented here, other sensors for vehicle sensor systems, such as acceleration sensors, rate-of-turn sensors, force sensors, structure-borne sound sensors, air pressure sensors, and surroundings sensors such as video, radar, LIDAR, or ultrasound, can be connected wirelessly to a control unit.

FIG. 2 shows the mode of operation of an active speed sensor which is connected to the power supply to operate at a voltage source. The sensors detect the change in magnetic flux density. In the present case, a Hall sensor is provided as sensor element 22, for example, which measures the change in the magnetic flux density of steel wheel 20. A magnet 21 is also provided, the magnetic field of which is changed by the rotating steel wheel. The resultant signal is a sinusoidal signal 23 which is forwarded to control unit ECU for further processing.

A further embodiment of speed sensors is depicted in FIG. 3. A multi-polar encoder 30 with alternating magnetic poles is provided as the wheel. The rotation of this wheel causes the magnetic flux to change in the case of sensor element 31. The signals from the sensor element are evaluated by an ASIC and transmitted as digital signals to a control unit ECU. These digital signals are labelled with reference character 32.

Known principles are the Hall effect, the anisotropic magnetoresisitive effect, and giant magnetoresistance (GMR effect). The signal is prepared by the ASIC and delivers a signal having a motion-dependent constant amplitude which is likewise transmitted wirelessly, in a continual manner for each sensor, to the control unit, where it is processed further in a microcontroller.

FIG. 4 shows, in a block diagram, the sensor module according to the invention, labelled with reference characters 40 through 45, and control unit ECU. The sensor module according to the invention includes a single device 40 for the simultaneous generation of the sensor signal and energy. Using energy management system 41, which is disposed on an ASIC in a typical manner, the energy is stored in an energy accumulator 42 e.g. a capacitor which is also used for EMC (electromagnetic compatibility). The sensor signal is transmitted to an analog-digital converter disposed inside or outside of microcontroller 43 to digitize the sensor signal. Microcontroller 43 stores digitized sensor signals in a circular buffer 44 and transmits the data from the circular buffer via a transceiver 45 using radio signals to a further transceiver 46 of control unit ECU when vehicle parameters such as the vehicle speed and/or events such as wheels being locked, or slip display this. These data can be obtained from the sensor signal itself or from control unit ECU. The radio traffic is therefore also designed to be bidirectional in the present case. The ASIC converts the sensor signal to a speed-dependent voltage signal which is processed digitally in the sensor module. Microcontroller 43 can convert the sensor signal into a control unit-specific signal, evaluate it, and store the data continually in the circular memory. The stored data are typically available, e.g. if there is an unreliable change in speed, and are forwarded to transceiver 45 to be transmitted to control unit ECU. Conversion in the ASIC or the microcontroller into a digital speed or acceleration signal simplifies the further processing. This speed or acceleration signal can be transmitted directly to control unit ECU using transmitter 45 or transceiver at fixed discrete time intervals, or the signal is further-processed and evaluated in advance in the microcontroller. The above-described speed-dependent or rule-based data transmission rate of transceiver 45 can then be set.

FIG. 5 shows a section of the sensor module according to the invention. A coil SP is connected to an ASIC for sensor processing PP and for energy generation EE. In particular, energy supply EE can charge a capacitor C or other capacitors or energy accumulators. The sensor signal, which has been prepared by sensor signal preprocessing PP, is transmitted to transceiver TX which transmits the data depending on the sensor signal via antenna AT.

One possible embodiment of transceiver TX is shown in FIG. 6. The digital signal can be converted to an analog signal to amplify it and then to modulate it e.g. using frequency spreading or frequency hopping. The modulation can take place digitally and another amplifier can be used after modulation. The receiver structure has the reverse design: A receiving antenna is usually followed by a frequency converter, an amplifier and filter, and digital signal processing.

FIG. 7 shows the method according to the invention, in a flow chart. In method step 700, the sensor signal and energy are generated simultaneously e.g. using coil SP. The sensor signal is preprocessed in method step 701 and delivers e.g. parameters that energy management requires in method step 702 to decide whether to switch between a low power mode and a high power mode of the sensor module. The preprocessed sensor signal is stored for transmission in method step 704, and is transmitted in method step 705. The control unit decides, on the basis of vehicle parameters and/or the event, whether the transmission should take place or not. Energy management is operated at the same time, because a great deal of energy is required for the transmission state, and little is required solely to perform measurements. In method step 703, the energy management system decides how much energy should be provided, e.g. high power mode or low power mode, or what consumption can be set using the clock rate of the processing or the transmission rate of the transmission via transmitter TX.

What is claimed is:

1. A sensor module for a vehicle safety system, wherein the sensor module comprises at least one transmitter (TX) for the wireless transmission of data depending on a sensor signal, the sensor module using a measurement principle that functions as a generator, thereby generating energy to operate the sensor module, characterized in that
the sensor module includes a memory for the data, and a control unit that reads out and transmits data from the memory as a function of at least one vehicle parameter and/or one event.

2. The sensor module according to claim 1,
characterized in that
the memory is designed as a circular memory.

3. The sensor module according to claim 1,
characterized in that
the memory and the control unit are disposed on an integrated circuit.

4. The sensor module according to claim 1,
characterized in that
the vehicle parameter is the vehicle speed.

5. The sensor module according to claim 1,
characterized in that
the event is a wheel state.

6. The sensor module according to claim 1,
characterized in that
the sensor module comprises energy management with a converter that switches between a low power mode and a high power mode depending on the vehicle parameter and/or the event.

7. The sensor module according to claim 6,
characterized in that
the low power mode is provided for generating data, and the high power mode is provided for generating data and for transmission.

8. The sensor module according to claim 7,
characterized in that
the high power mode requires a higher clock rate in the sensor module.

9. The sensor module according to claim 1,
characterized in that
the measurement principle is inductive.

10. A method for operating a sensor module for a vehicle safety system, wherein data are transmitted wirelessly by at least one transmitter of the sensor module depending on a sensor signal, wherein the sensor module uses a measurement principle that functions as a generator, and therefore the energy required to operate the sensor module is generated by this measurement principle,
characterized in that
the data are stored in a memory in the sensor module, and a control unit in the sensor module reads out and transmits data from the memory as a function of at least one vehicle parameter and/or one event.
